(19) United States
(12) Patent Application Publication
(10) Pub. No.: US 2022/0221121 A1
(43) Pub. Date: Jul. 14, 2022

(54) LIGHTING APPARATUS FOR VEHICLE AND METHOD OF MANUFACTURING THE SAME

(71) Applicant: HYUNDAI MOBIS Co., Ltd., Seoul (KR)

(72) Inventor: Moon Sub HWANG, Yongin-si (KR)

(73) Assignee: HYUNDAI MOBIS Co., Ltd., Seoul (KR)

(21) Appl. No.: 17/570,835

(22) Filed: Jan. 7, 2022

(30) Foreign Application Priority Data
Jan. 8, 2021 (KR) 10-2021-0002889
Jan. 8, 2021 (KR) 10-2021-0002890

(51) Int. Cl. F21S 41/20; F21S 41/141; F21S 41/19

(52) U.S. Cl. CPC F21S 41/28; F21S 41/19; F21S 41/141

(57) ABSTRACT

Disclosed is a lighting apparatus and a method of manufacturing the same, which may improve an external appearance and marketability, the apparatus including a light transmissive lighting cover configured to transmit light through a first surface and a second surface thereof, and an LED module having an LED mounted on the second surface of the light transmissive lighting cover to emit light, wherein the light transmissive lighting cover includes a design pattern portion formed by the transmission of the light when the LED is turned on, a painted portion formed on the first surface of the light transmissive lighting cover, the painted surface being visible, in response to the LED being turned off, and a metal deposition surface formed on the painted portion.

This application claims the benefit of Korean Patent Application Nos. 10-2021-0002889 and 10-2021-0002890, both filed on Jan. 8, 2021 in the Korean Intellectual Property Office, the entire disclosures of which are incorporated herein by reference for all purposes.

### BACKGROUND

### 1. Field

The present disclosure relates to a lighting apparatus for a vehicle capable of improving an external appearance marketability of a vehicle and serving as an interaction lamp for an autonomous vehicle, and a method of manufacturing the same.

### 2. Description of Related Art

In general, a radiator grille (hereinafter, referred to as a ‘grille’) for a vehicle is mounted on a front surface of a front bumper and serves as a front bumper grille and a ventilation port for smoothly transferring outside air to a radiator and a condenser through openings. The grille greatly contributes to the natural function and improvement in external appearance images and styling of the vehicle.

Recently, the importance of the function of cooling an engine, which is an original function of the radiator grille, decreases as the concept of the vehicle tends to change from internal combustion engine vehicles and manned driving vehicles to environmentally friendly vehicles (electric vehicles, fuel cell vehicles, and the like) and autonomous vehicles. Therefore, there is a tendency to improve aerodynamics of the vehicle by not applying openings to the grille. Further, a dummy grille with plain design is applied, or a simple surface treatment is performed on a portion, where there were the openings, by painting the portion in a color identical to a color of a vehicle body.

FIG. 1A illustrates a front appearance of a vehicle equipped with a dummy grille 12 mounted on a portion where there were openings of a front bumper 10 in the related art.

Meanwhile, recently, a bumper and a lamp are fused to cope with a tendency to improve utilization of the lamp in the related art like a daytime running light (DRL) separately provided or an interaction lamp for an autonomous vehicle. Therefore, a separate lamp-grille matching structure needs to be applied, but the separate assembly structure exposes an external appearance parting line, which degrades an aesthetic appearance or design quality of the vehicle.

FIG. 1B illustrates a parting line 18 exposed between a grille 14 and a DRL 16 of a vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a lighting apparatus for a vehicle, the apparatus including a light transmissive lighting cover configured to transmit light through a first surface and a second surface thereof, and an LED module having an LED mounted on the second surface of the light transmissive lighting cover to emit light, wherein the light transmissive lighting cover includes a design pattern portion formed by the transmission of the light when the LED is turned on, a painted portion formed on the first surface of the light transmissive lighting cover, the painted surface being visible, in response to the LED being turned off, and a metal deposition surface formed on the painted portion.

The painted portion of the light transmissive lighting cover may have a grille shape for a vehicle.

The painted portion of the light transmissive lighting cover may be painted in a black color.

The light transmissive lighting cover may include a diffusion paint layer formed on the metal deposition surface.

The light transmissive lighting cover may be made of polycarbonate (PC).

The lighting apparatus may include a housing on which the LED module may be mounted, wherein the housing may be attached to the second surface of the light transmissive lighting cover.

The lighting apparatus may include hot melt configured to join the light transmissive lighting cover and the housing.

The lighting apparatus may include a light guide configured to transmit the light, emitted from the LED mounted on the LED module, to the second surface of the light transmissive lighting cover.

The light guide may have a solid shape.

The light guide may have a string shape.

In another general aspect, there is provided a method of manufacturing a lighting apparatus for a vehicle, the method including forming a design pattern portion by transmission of light when an LED is turned on, on a light transmissive lighting cover configured to transmit light through first and second surfaces thereof, forming a painted portion visible when the LED is turned off, on the first surface of the light transmissive lighting cover, forming a metal deposition surface on the painted portion of the light transmissive lighting cover, and mounting an LED module comprising the LED, on the second surface of the light transmissive lighting cover.

The painted portion formed on the light transmissive lighting cover may have a grille shape for a vehicle.

The painted portion of the light transmissive lighting cover may be painted in a black color.

The method may include forming a diffusion paint layer on the metal deposition surface.

The light transmissive lighting cover may be made of polycarbonate (PC).

The method may include attaching the LED module to a housing and mounting the housing on the light transmissive lighting cover.

The method may include interposing hot melt between the light transmissive lighting cover and the housing when mounting the housing on the light transmissive lighting cover.

The method may include installing a light guide configured to transmit the light emitted from the LED, to the second surface of the light transmissive lighting cover.

The light guide may have a solid shape made of a light transmissive material.

The light guide may have a string shape made of a light transmissive material.

Other features and aspects will be apparent from the following detailed description, the drawings, and the claims.

### BRIEF DESCRIPTION OF THE DRAWINGS

FIG. 1A is a view illustrating a front appearance of a vehicle equipped with a dummy grille 12 mounted on a front bumper 10 in the related art.

FIG. 1B is a view illustrating a parting line 18 exposed between a grille 14 and a daytime running light (DRL) 16 of a vehicle.

FIGS. 2 to 5 are views for explaining a lighting apparatus for a vehicle according to an embodiment of the present disclosure, in which

FIG. 2 is an exploded view of the lighting apparatus for a vehicle according to the present embodiment,

FIG. 3 is a view illustrating an assembly of the lighting apparatus for a vehicle made by assembling components illustrated in FIG. 2,

FIG. 4 is a cross-sectional view for explaining an operation of the lighting apparatus for a vehicle according to the present disclosure in an LED off state, and

FIG. 5 is a cross-sectional view for explaining an operation of the assembly of the lighting apparatus for a vehicle according to the present embodiment in a light on state.

FIGS. 6 to 10 are views for explaining a lighting apparatus for a vehicle according to another embodiment of the present disclosure to which light guides are added, in which

FIG. 6 is an exploded view of the lighting apparatus for a vehicle according to the present embodiment,

FIG. 7 is a view illustrating an assembly of the lighting apparatus for a vehicle made by assembling components illustrated in FIG. 6,

FIG. 8 is a cross-sectional view for explaining an operation of the lighting apparatus for a vehicle according to the present embodiment in an LED off state,

FIG. 9 is an exemplified view illustrating a structure in which an LED 31 of an LED module 30 is in contact with an end of a light guide 60, and

FIG. 10 is a cross-sectional view for explaining an operation of the assembly of the lighting apparatus for a vehicle according to the present embodiment in a light on state.

FIG. 11 is a front view of a lighting cover 20, i.e., a view for explaining a relationship between the number of light guides 60 and the number of LED.

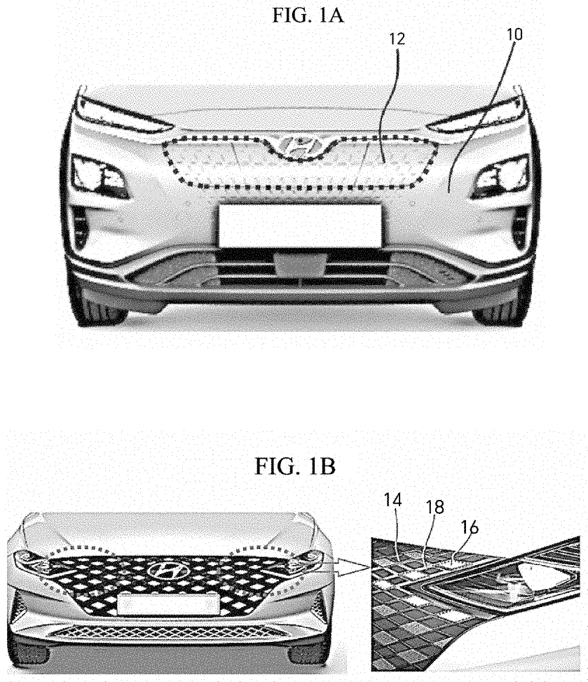

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for the purpose of describing particular examples only and is not to be limiting of the examples. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

When describing the examples with reference to the accompanying drawings, like reference numerals refer to like constituent elements and a repeated description related thereto will be omitted. In the description of examples, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one constituent element from another constituent element, and the nature, the sequences, or the orders of the constituent elements are not limited by the terms. When one constituent element is described as being “connected”, “coupled”, or “attached” to another constituent element, it should be understood that one constituent element can be connected or attached directly to another constituent element, and an intervening constituent element can also be “connected”, “coupled”, or “attached” to the constituent elements.

Hereinafter, the embodiments of the present disclosure will be described in detail with reference to the accompanying drawings. In the description of the embodiments, the specific descriptions of publicly known related configurations or functions will be omitted when it is determined that the specific descriptions may obscure the subject matter of the present disclosure.

### Embodiment 1

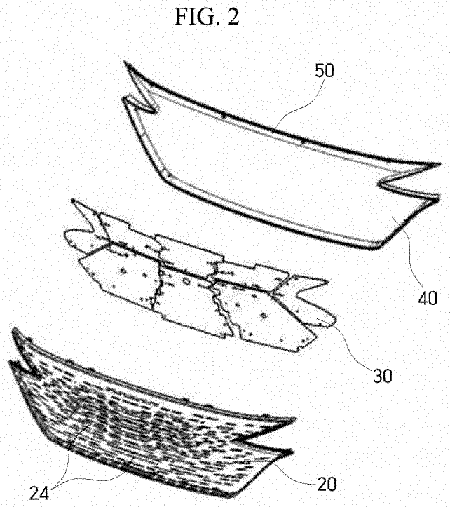

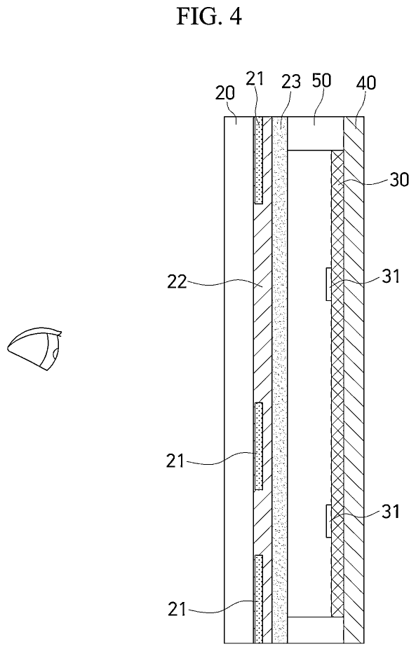

FIG. 2 is an exploded view of a lighting apparatus for a vehicle according to an embodiment of the present disclosure. The components of the lighting apparatus for a vehicle according to the present embodiment will be described with reference to FIG. 4 for explaining an operation of the lighting apparatus in an LED off state.

A lighting cover 20 refers to a cover made of a light transmissive material (e.g., a transparent or semi-transparent material) capable of transmitting light through front and rear sides thereof. Design pattern portions 24 are formed on the lighting cover 20 to implement predetermined design (letters, figures, indication of directions, other messaging means) by the transmission of light in an LED on state. Further, a painted portion (21 in FIG. 4), for example, a black-color painted portion is applied to implement a grille shape on a front surface of the lighting cover 20 in an LED off state. The black-color painted portion may be formed on a rear surface of the lighting cover 20 through a masking painting method so that the design pattern portions 24 are not painted. However, the black-colored painting may be formed on a center layer of the lighting cover 20. A half mirror is implemented by depositing metal (e.g., aluminum (Al)) on the entire surface of the painted portion 21 after the painted portion 21 is formed.

Therefore, when the lighting apparatus is turned on and the rear surface of the lighting cover 20 is illuminated with light in a traveling or welcome state, the light passing through the lighting cover 20 made of a light transmissive material may be visible from the outside of the cover through the metal (such as Al, etc.) deposition surface, i.e., the half mirror (in this case, the patterns of the design pattern portions 24 appear). In contrast, when the lighting apparatus is turned off and the rear surface of the lighting cover 20 is not illuminated with light, the design pattern portions 24 of the cover are not visible, and the Al deposition surface of the lighting cover 20 serves as a reflector, such that the painted portion 21 disposed on the front surface of the cover appears in a shape similar to a grille shape of a vehicle equipped with an internal combustion engine, for example.

Because the lighting cover 20 is exposed to the outside of the vehicle, hard coating is preferably applied to the exposed surface of the lighting cover 20, but the present disclosure is not limited thereto. In addition, the lighting cover 20 may be made of, but not limited to, polycarbonate (PC).

An LED module 30 refers to a module provided in the form of a PCB or the like on which LED are mounted to emit light to the rear surface of the lighting cover 20. The LED module 30 is mounted on a housing.

The LED module 30 is mounted on a housing 40, and the housing 40 is attached to the rear surface of the lighting cover 20 and serves as a rear cover. The housing 40 may be made of PP-TD30. Further, the housing 40 may be manufactured in, but not limited to, a black color to block light emitted from the outside.

Hot melt 50 is positioned between the lighting cover 20 and the housing 40 and serves to join the lighting cover 20 and the housing 40 at the time of attaching the housing 40 to the lighting cover 20. Therefore, the hot melt 50 serves to protect elements and prevent moisture from being introduced between the lighting cover 20 and the housing 40, i.e., between the lighting cover 20 and the LED module 30. The hot melt 50 may be made of urethane.

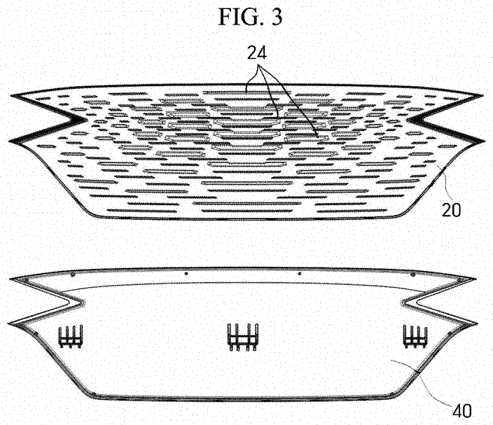

FIG. 3 illustrates an assembly of the lighting apparatus for a vehicle according to the present embodiment made by assembling the components illustrated in FIG. 2. The top side of FIG. 3 illustrates a front surface of the assembly, and the bottom side of FIG. 3 illustrates a rear surface of the assembly. The assembly of the lighting apparatus for a vehicle assembled as described above may be installed at a position of a grille opening of a front bumper to overcome a limitation of a plain dummy grille of an electric vehicle and implement a lamp interaction function of an autonomous vehicle. Alternatively, the assembly of the lighting apparatus may be installed on a rear bumper, a roof, a trunk, a hood, or the like of the vehicle to implement various interaction functions or messaging functions.

FIG. 4 is a cross-sectional view for explaining an operation of the lighting apparatus for a vehicle according to the present embodiment in an LED off state.

The design pattern portions (not illustrated) having predetermined patterns are formed on the lighting cover 20 made of a transparent material (PC), and for example, the painted portion 21 having a shape similar to the grille shape is formed on the lighting cover 20. Further, an Al deposition surface 22 is formed on the entire painted portion 21. Optionally, a diffusion paint layer 23 may be applied onto the Al deposition surface. When the LED light is emitted from the LED module 30 to the rear surface of the cover 20, the diffusion paint layer 23 serves to uniformly diffuse the light and transmit the light to the lighting cover 20.

The LED module 30 is positioned on the rear surface of the lighting cover 20. Further, the LED module 30 is mounted on the housing 40, and the housing 40 is attached to the lighting cover 20 by the hot melt 50. As described above, the hot melt 50 serves to prevent the penetration of moisture and protect the electronic elements of the LED module.

With the configuration illustrated in FIG. 4, in a state in which LED 31 of the LED module 30 are turned off (e.g., a state in which the vehicle is stationary), the painted portion 21 and the Al deposition (half mirror) on the rear surface of the lighting cover 20 make the external appearance (the front surface) of the lighting apparatus for a vehicle according to the present disclosure seem to have a painted shape. For example, the painted portion 21 having the pattern in a grille shape appears like a grille plated with chromium. Therefore, it is possible to implement an image of a general radiator grille of a vehicle equipped with an internal combustion engine.

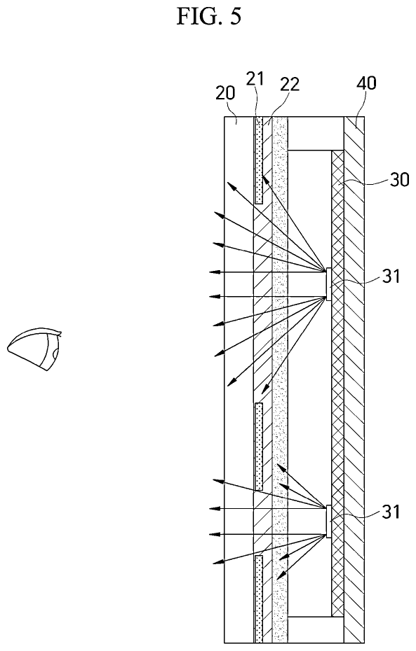

FIG. 5 is a cross-sectional view for explaining an operation of the assembly of the lighting apparatus for a vehicle according to the present embodiment in an LED on state. It can be seen from FIG. 5 that the light emitted from the LED of the LED module 30 is transmitted to the diffusion paint layer 23 and the Al deposition surface 22 and passes through the lighting cover 20.

As described above, in the state in which the LED module 30 is turned on, e.g., in a traveling or welcome state (when a door is opened or locked), the light emitted from the LED 31 is transmitted to the front surface of the lighting cover 20 while passing through the Al deposition surface 22, but at the portions other than the design pattern portions, the light emitted from the LED 31 is blocked by the painted portion 21 and cannot be transmitted to the front surface of the lighting cover 20. Therefore, other persons may see the light emitted through the design pattern portions from the front surface of the lighting cover 20 and thus receive messages or perform interactions.

### <Embodiment 2> Lighting Apparatus for Vehicle to which Light Guide is Added

In Embodiment 2, light guides are used to illuminate the lighting cover 20 by transmitting (guiding) light without emitting light from the LED light source 31 directly to the lighting cover 20 according to Embodiment 1. The light guide disadvantageously reduces the light amount between an end of the LED light source 31 from which the light begins to be emitted and an end of the lighting cover 20 to which the light is transmitted. However, because it is not necessary to assign the LED to the respective design pattern portions, a small number of LED may be used, which makes it possible to reduce the number of LED and costs.

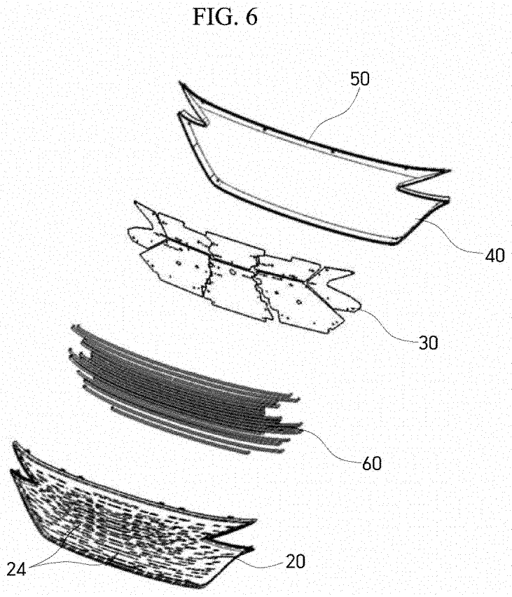

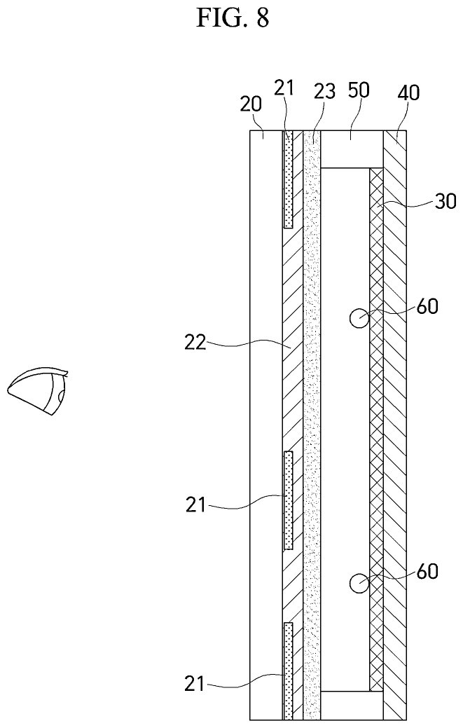

FIG. 6 is an exploded view of the lighting apparatus for a vehicle according to the present embodiment to which the light guides are added. The components of the lighting apparatus for a vehicle will be described with reference to FIG. 8 for explaining an operation of the lighting apparatus in an LED off state. Because the lighting cover 20, the LED module 30, the housing 40, and the hot melt 50 are identical to those in Embodiment 1 described above, the descriptions thereof will be omitted (see FIG. 2).

Light guides 60 added to the present embodiment serve to transmit the light, which is emitted from the LED module 30 mounted on the housing 40, to a desired position on the rear surface of the lighting cover 20. The light guide 60 may be formed (for example, by extrusion) in a solid shape by using a light transmissive material such as PC. However, the light guide 60 may be provided in the form of a more flexible string in a case in which the light guide 60 is greatly curved or the LED is distant from the design pattern portion. The light guide 60 disadvantageously reduces the light amount between an end of the LED light source from which the light begins to be emitted and an end of the lighting cover to which the light is transmitted. However, because it is not necessary to assign the LED to the respective design pattern portions, a small number of LED may be used, which makes it possible to reduce the number of LED and costs.

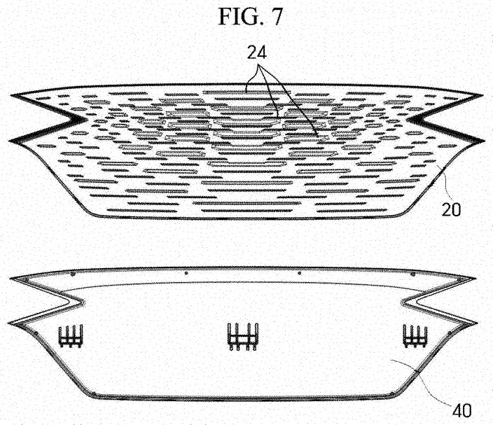

FIG. 7 illustrates the assembly of the lighting apparatus for a vehicle made by assembling the components illustrated in FIG. 6, and the assembly illustrated in FIG. 7 is practically identical to the assembly in Embodiment 1 illustrated in FIG. 3. This is because the above-mentioned components are embedded in a space between the front and rear surfaces of the assembly.

FIG. 8 is a cross-sectional view for explaining an operation of the lighting apparatus for a vehicle according to the present embodiment in an LED off state.

Like FIG. 4 for explaining Embodiment 1, the design pattern portions (not illustrated) having predetermined patterns are formed on the lighting cover 20 made of a transparent material (e.g., polycarbonate (PC)), and for example, the painted portion 21 having a shape similar to the grille shape is formed on the lighting cover 20. Further, the Al deposition surface 22 is formed on the entire painted portion 21. Optionally, the diffusion paint layer 23 may be applied onto the Al deposition surface. When the LED light is emitted from the LED module 30 to the rear surface of the cover 20 through the light guides 60, the diffusion paint layer 23 serves to uniformly diffuse the light and transmit the light to the lighting cover 20. However, the diffusion paint layer 23 may be omitted in accordance with the material and shape design of the light guide 60.

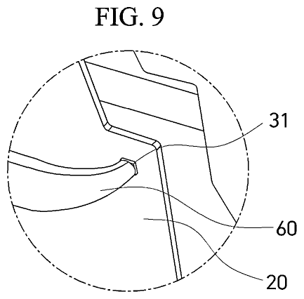

The light guide 60 is positioned on the rear surface of the lighting cover 20, and the LED of the LED module 30 is in contact with the light guide 60. FIG. 9 illustrates a structure in which the LED 31 of the LED module 30 is in contact with an end of the light guide 60. Therefore, it is possible to illuminate a relatively wide area with light by using a small number of LED 31 and a small number of light guides 60. As described above, a light string may be used as the light guide 60 in the case in which a light illumination area is greatly curved, or it is difficult to make the LED 31 be in contact with the light guide 60 because of a structurally large distance or a narrow space between the LED 31 and the light guide 60.

The LED module 30 is mounted on the housing 40, and the housing 40 is attached to the lighting cover 20 by the hot melt 50. As described above, the hot melt 50 serves to prevent the penetration of moisture and protect the electronic elements of the light guides 60 and the LED module.

With the configuration illustrated in FIG. 8, in a state in which the LED module 30 is turned off (e.g., a state in which the vehicle is stationary), the painted portion 21 and the Al deposition (half mirror) on the rear surface of the lighting cover 20 make the external appearance (the front surface) of the lighting apparatus for a vehicle according to the present disclosure seem to have a painted shape. For example, the painted portion 21 having the pattern in a grille shape appears like a grille plated with chromium. Therefore, it is possible to implement an image of a general radiator grille of a vehicle equipped with an internal combustion engine.

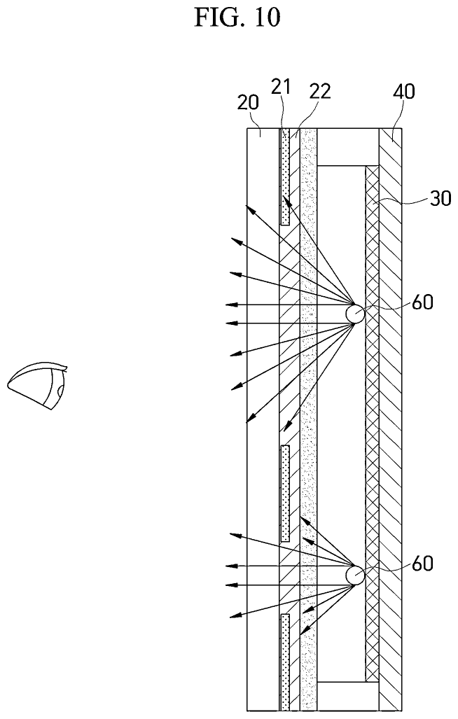

FIG. 10 is a cross-sectional view for explaining an operation of the assembly of the lighting apparatus for a vehicle according to the present embodiment in the LED on state. It can be seen from FIG. 10 that the light emitted from the LED of the LED module 30 is transmitted to the diffusion paint layer 23 and the Al deposition surface 22 through the light guides 60 and passes through the lighting cover 20.

As described above, in the state in which the LED module 30 is turned on, e.g., in a traveling or welcome state (when a door is opened or locked), the light emitted from the LED 31 is transmitted to the front surface of the lighting cover 20 through the light guides 60 while passing through the Al deposition surface 22, but at the portions other than the design pattern portions, the light emitted from the LED is blocked by the painted portion 21 and cannot be transmitted to the front surface of the lighting cover 20. Therefore, other persons may see the light emitted through the design pattern portions from the front surface of the lighting cover 20 and thus receive messages or perform interactions.

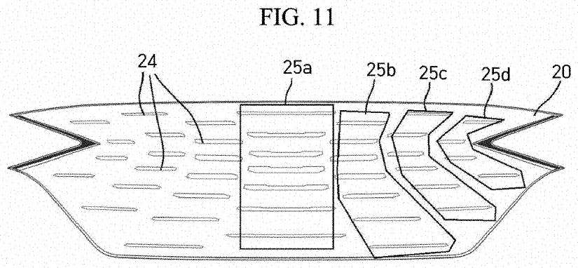

FIG. 11 is a view for explaining a relationship between the number of LED in Embodiment 1 and the number of LED in Embodiment 2.

The plurality of design pattern portions 24 each having a horizontal line shape is vertically arranged on the lighting cover 20. The respective arranged design pattern portions 24 are grouped in a design pattern portion group 25a vertically arranged in a central column, a design pattern portion group 25b vertically arranged in a first column at a right side of the central column, a design pattern portion group 25c vertically arranged in a second column, and a design pattern portion group 25d vertically arranged in a third column. When the light guides 60 are vertically disposed one for each group in each column, the respective design pattern portions 24 in the central column group 25a, the first column group 25b, the second column group 25c, and the third column group 25d may be expressed by using a small number of LED. If the light guide 60 is not used, the LED need to be assigned to the respective design pattern portions 24 (or the several design pattern portions 24), which increases the number of LED.

The lighting apparatus for a vehicle and the method of manufacturing the same according to the present disclosure may be applied to a front bumper, a rear bumper, a fender, a roof, a window, and the like of the vehicle. The effects of the present disclosure are as follows.

1) Implementation of various color lighting and animation effects (improvement in external appearance marketability) by means of design pattern portions by using light-emitting elements such as LED.

2) Removal of parting lines of light parts (improvement in degree of design freedom) by integrating the vehicle body (e.g., the radiator grille) and the lamp structure.

3) Implementation of a design shape (e.g., chromium radiator grille design) in the related art by a half mirror deposition part in the LED off state.

4) Discrimination from other persons (customizing function) by obtaining desired lighting patterns and effects by using LED module control applications by a consumer.

In particular, in the case in which the lighting apparatus for a vehicle according to the present disclosure is installed at a position corresponding to a grille opening which is not provided in the environmentally friendly vehicle (the electric vehicle or the fuel cell vehicle) and the autonomous vehicle, it is possible to implement various design by applying various lighting colors and animation instead of plain dummy grille design, improve the external appearance and marketability, and perform the interaction lamp function using the simple lighting pattern such as indication of directions correspondingly to the interaction lamp function of the autonomous vehicle.

The lighting apparatus described herein, may improve an external appearance marketability based on the tendency not to apply openings to radiator grilles of an environmentally friendly vehicle (an electric vehicle or a fuel cell vehicle) and an autonomous vehicle, provide an interaction lamp function of an autonomous vehicle, serve to perform a recent function of communication or message delivery between drivers as well as a simple lighting function of a vehicle, and apply to a vehicle by reflecting the lighting function that has a tendency to contribute to one design feeling quality.

As described above, the lighting apparatus for a vehicle using aluminum deposition and a light guide may include a light transmissive lighting cover capable of transmitting light through a first surface and a second surface, an LED module having an LED mounted on the second surface of the lighting cover to emit light, and a light guide configured to transmit the light, emitted from the LED mounted on the LED module, to the second surface of the lighting cover. In this case, the lighting cover may include: a design pattern portion implemented by the transmission of the light when the LED is turned on; a painted portion formed on the first surface of the lighting cover so as to be visible when the LED is turned off (for example, the painted portion painted in a grille shape by using black paint); and a metal (e.g., Al) deposition surface formed on the painted portion.

As described above, the lighting apparatus for a vehicle using aluminum deposition and an LED light source includes a light transmissive lighting cover capable of transmitting light through a first surface and a second surface thereof, and an LED module having an LED mounted on the second surface of the lighting cover to emit light. In this case, the lighting cover may include: a design pattern portion implemented by the transmission of the light when the LED is turned on, a painted portion formed on the first surface of the lighting cover so as to be visible when the LED is turned off (for example, the painted portion painted in a grille shape by using black paint), and a metal deposition surface formed on the painted portion. Herein, the metal deposition surface may be aluminum (Al) deposition surface, but not limited thereto.

With this configuration, in the LED off state, the metal (e.g., Al) deposition surface (half mirror) and painted portion on the second surface of the lighting cover may make the shape of the painted portion visible on the first surface of the lighting cover.

In contrast, in the LED on state, the light emitted from the LED is transmitted to the front surface of the lighting cover through the light guide or directly through the metal deposition surface, but at the portions other than the design pattern portions, the light emitted from the LED is blocked by the painted portion and cannot be transmitted to the front surface of the lighting cover. Therefore, the light implemented by the design pattern portions appears on the first surface of the lighting cover.

The lighting apparatus disclosed herein may improve an external appearance and marketability, based on the tendency not to apply openings to radiator grilles of an environmentally friendly vehicle (an electric vehicle or a fuel cell vehicle) and an autonomous vehicle, provide an interaction lamp function of an autonomous vehicle, serve to perform a recent function of communication or message delivery between drivers as well as a simple lighting function of a vehicle, and apply to a vehicle by reflecting the lighting function that has a tendency to contribute to one design feeling quality.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lighting apparatus for a vehicle, the apparatus comprising:
a light transmissive lighting cover configured to transmit light through a first surface and a second surface thereof; and
an LED module having an LED mounted on the second surface of the light transmissive lighting cover to emit light,
wherein the light transmissive lighting cover comprises:
a design pattern portion formed by the transmission of the light when the LED is turned on;
a painted portion formed on the first surface of the light transmissive lighting cover, the painted surface being visible, in response to the LED being turned off; and
a metal deposition surface formed on the painted portion.

2. The lighting apparatus of claim 1, wherein the painted portion of the light transmissive lighting cover has a grille shape for a vehicle.

3. The lighting apparatus of claim 1, wherein the painted portion of the light transmissive lighting cover is painted in a black color.

4. The lighting apparatus of claim 1, wherein the light transmissive lighting cover further comprises a diffusion paint layer formed on the metal deposition surface.

5. The lighting apparatus of claim 1, wherein the light transmissive lighting cover is made of polycarbonate (PC).

6. The lighting apparatus of claim 1, further comprising:
a housing on which the LED module is mounted,
wherein the housing is attached to the second surface of the light transmissive lighting cover.

7. The lighting apparatus of claim 6, further comprising:
hot melt configured to join the light transmissive lighting cover and the housing.

8. The lighting apparatus of claim 1, further comprising:
a light guide configured to transmit the light, emitted from the LED mounted on the LED module, to the second surface of the light transmissive lighting cover.

9. The lighting apparatus of claim 8, wherein the light guide has a solid shape.

10. The lighting apparatus of claim 8, wherein the light guide has a string shape.

11. A method of manufacturing a lighting apparatus for a vehicle, the method comprising:
forming a design pattern portion by transmission of light when an LED is turned on, on a light transmissive lighting cover configured to transmit light through first and second surfaces thereof;
forming a painted portion visible when the LED is turned off, on the first surface of the light transmissive lighting cover;
forming a metal deposition surface on the painted portion of the light transmissive lighting cover; and
mounting an LED module comprising the LED, on the second surface of the light transmissive lighting cover.

12. The method of claim 11, wherein the painted portion formed on the light transmissive lighting cover has a grille shape for a vehicle.

13. The method of claim 11, wherein the painted portion of the light transmissive lighting cover is painted in a black color.

14. The method of claim 11, further comprising:
forming a diffusion paint layer on the metal deposition surface.

15. The method of claim 11, wherein the light transmissive lighting cover is made of polycarbonate (PC).

16. The method of claim 11, further comprising:
attaching the LED module to a housing and mounting the housing on the light transmissive lighting cover.

17. The method of claim 16, further comprising:
interposing hot melt between the light transmissive lighting cover and the housing when mounting the housing on the light transmissive lighting cover.

18. The method of claim 11, further comprising:
installing a light guide configured to transmit the light emitted from the LED, to the second surface of the light transmissive lighting cover.

19. The method of claim 18, wherein the light guide has a solid shape made of a light transmissive material.

20. The method of claim 18, wherein the light guide has a string shape made of a light transmissive material.
